(19) United States
(12) Patent Application Publication
(10) Pub. No.: US 2025/0360701 A1
(43) Pub. Date: Nov. 27, 2025

(54) MULTILAYER POLYETHYLENE FILM

(71) Applicant: BOREALIS AG, Vienna (AT)

(72) Inventors: Jingbo WANG, Linz (AT); Friedrich BERGER, Linz (AT); Arnaud ALABRUNE, Courbevoie (FR); Chantal SEMAAN, Barcelona (ES); Anthony BERTHELIER, Courbevoie (FR)

(73) Assignee: BOREALIS AG, Vienna (AT)

(21) Appl. No.: 18/864,821

(22) PCT Filed: May 16, 2023
(86) PCT No.: PCT/EP2023/063063

§ 371 Date: Nov. 11, 2024

(30) Foreign Application Priority Data
May 17, 2022 (EP) 22173822.2

(51) Int. Cl. B32B 27/32; B32B 27/08

(52) U.S. Cl. CPC B32B 27/32; B32B 27/08; B32B 2250/242; B32B 2305/70; B32B 2307/72; B32B 2307/7376

(57) ABSTRACT

The invention relates to a multilayer polyethylene film comprising a skin layer, a sealant layer and a core layer located between the skin layer and the sealant layer, wherein the core layer comprises a core layer composition, the core layer composition comprising a recycled polyethylene having an MFR₂ of 0.1 to 2.0 g/10 min determined according to ISO 1133 and a density of 910 to 930 kg/m³ determined according to ISO 1183, a multimodal ethylene terpolymer having an MFR₂ of 0.5 to 2.0 g/10 min determined according to ISO 1133 and a density of 910 to 930 kg/m³ determined according to ISO 1183, and a polyethylene having an MFR5 of 0.1 to 2.5 g/10 min determined according to ISO 1133 and a density of 925 to 950 kg/m³ determined according to ISO 1183. The invention further relates to a process for producing the multilayer polyethylene film, the use of the core layer composition as a core layer in a multilayer polyethylene film for improving the haze and the SIT of the multilayer polyethylene film and an article comprising the multilayer polyethylene film.

The present invention relates to a multilayer polyethylene film comprising a skin layer, a sealant layer and a core layer located between the skin layer and the sealant layer. The invention further relates to a process for producing the multilayer polyethylene film, a core layer composition and the use of the core layer composition as a core layer in a multilayer polyethylene film as well as an article comprising the core layer composition or the multilayer polyethylene film.

Polyethylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes.

It is thus important to form a circular economy that brings plastic waste back to a second life, i.e. to recycle it. This not only avoids leaving plastic waste in the environment but also recovers its value.

In addition, the European Commission confirmed in 2017 that it would focus on plastics production and use. The EU goals are that 1) by 2025 at least 55% of all plastics packaging in the EU should be recycled and 2) by 2030 all plastic packaging placed in the EU market is reusable or easily recycled. This pushes the brand owners and plastic converters to pursue solutions with recyclate or virgin/recyclate blends.

Thus, there is an increasing importance to include polymers obtained from waste materials for the manufacturing of new products, i.e. wherein waste plastics (e.g. post-consumer recyclate (PCR)) can be turned into resources for new plastic products. Hence, environmental and economic aspects can be combined in recycling and reusing waste plastics material.

However, recycled plastics are normally inferior to virgin plastics in their quality due to degradation, contamination and mixing of different plastics. However, a balanced behavior of impact strength (e.g. dart impact) and mechanical properties (e.g. toughness, tensile strength) as well as good aesthetic performance (e.g. in terms of haze and transparency) of the films are desirable for packaging applications. Also sealing performance is an important requirement in packaging applications.

In addition, compositions containing recycled polyolefin materials normally have properties, which are much worse than those of the virgin materials, unless the amount of recycled polyolefin added to the final composition is extremely low. For example, such materials often have limited impact strength and poor mechanical properties and thus, they do not fulfil customer requirements.

Blending recycled plastics with virgin plastics is a common practice of improving the quality of recycled plastics.

It is therefore an object of the present invention to provide a multilayer polyethylene film partially made from recycled polyethylene, in particular to provide a multilayer polyethylene film comprising a core layer partially made from recycled polyethylene.

It is a further object of the present invention to provide a multilayer polyethylene film having good mechanical properties, in particular toughness, and at the same time improved optical properties, such as haze.

It is a further object of the present invention to provide a multilayer polyethylene film having good sealing performance, i.e. having a low seal initiation temperature (SIT).

Finally, it is an object of the present invention to provide a core layer composition for a multilayer film allowing the use of recycled polyethylene, in particular the use of recycled polyethylene in high amounts in the core layer composition.

The invention thus provides a multilayer polyethylene film comprising, preferably consisting of,
a skin layer, a sealant layer and a core layer located between the skin layer and the sealant layer,
wherein the core layer comprises, or consists of, a core layer composition, the core layer composition comprising, preferably consisting of,
a) a recycled polyethylene having an MFR₂ of 0.1 to 2.0 g/10 min, determined according to ISO 1133 and a density of 910 to 930 kg/m³ determined according to ISO 1183,
b) a multimodal ethylene terpolymer having an MFR₂ of 0.5 to 2.0 g/10 min determined according to ISO 1133, a density of 910 to 930 kg/m³ determined according to ISO 1183, and a MWD of 2.0 to 7.5 determined by GPC (Gel Permeation Chromatography),
c) a polyethylene having an MFR₅ of 0.1 to 2.5 g/10 min, determined according to ISO 1133, a density of 925 to 950 kg/m³, determined according to ISO 1183 and a MWD of 8.0 to 35.0 determined by GPC (Gel Permeation Chromatography).

The present invention is based on the finding that such multilayer polyethylene films with improved mechanical and optical properties and at the same time low seal initiation temperature (SIT) can be provided by using a recycled polyethylene as a component of the core layer composition, the core layer composition forming the core layer of the multilayer polyethylene film.

It has also been surprisingly found that high amounts of recycled polyethylene can be used in the core layer composition, i.e. up to 95 wt. %, without deteriorating the mechanical and optical properties of the multilayer polyethylene film.

Apart from using high amounts of recycled polyethylene in the core layer composition of the multilayer polyethylene films according to the invention, also the other polymer components used for the layers of the films are polyethylene-based materials. In other words, the multilayer polyethylene films according to the invention are based on or formed from polyethylene-based materials, i.e. the inventive multilayer films aim towards monomaterial solutions based on polyethylene. Hence, the multilayer polyethylene films according to the invention have the twofold advantage that the multilayer films are structurally made from monomaterial polyethylene and a high amount of recycled polyethylene can be used for their core layer. The inventive multilayer polyethylene films are thus designed for recycling.

The multilayer film according to the invention has at least three layers, namely a skin layer, a sealant layer and a core layer located between the skin layer and the sealant layer. Usually, the multilayer polyethylene film according to the invention has not more than 7 layers, preferably not more than 5 layers.

Preferably, the multilayer polyethylene film according to the invention has or consists of three layers, that is the multilayer polyethylene film according to the invention consists of the skin layer, the sealant layer and the core layer located between the skin layer and the sealant layer as described herein. In other words, the multilayer polyethylene film according to the invention is preferably a three-layer polyethylene film.

Alternatively, the multilayer polyethylene film according to the invention preferably further comprises other layer(s) apart from the skin layer, the sealant layer and the core layer as described herein. If present, the other layer(s) are located between the skin layer and the core layer and/or between the sealant layer and the core layer. Preferably, the other layer(s) is/are composed of a polyethylene-based composition.

Preferably, the skin layer and the sealant layer are the outermost layers of the multilayer polyethylene film.

### Core Layer

The core layer comprises, or consists of, a core layer composition. The core layer composition comprises as a main component the recycled polyethylene a).

For the purposes of the present description and of the subsequent claims, the term “recycled polyethylene” indicates a polymer material including predominantly units derived from ethylene apart from other polymeric ingredients of arbitrary nature. Such polymeric ingredients may for example originate from monomer units derived from alpha olefins such as propylene, butylene, hexene, octene, and the like, styrene derivatives such as vinylstyrene, substituted and unsubstituted acrylates, substituted and unsubstituted methacrylates.

Said polymeric materials can be identified in the mixed-plastic polyethylene composition by means of quantitative ¹³C{1H} NMR measurements as described herein. In the quantitative ¹³C{1H} NMR measurement used herein and described below in the measurement methods different units in the polymeric chain can be distinguished and quantified. These units are ethylene units (C2 units), units having 3, 4 and 6 carbons and units having 7 carbon atoms.

Thereby, the units having 3 carbon atoms (C3 units) can be distinguished in the NMR spectrum as isolated C3 units (isolated C3 units) and as continuous C3 units (continuous C3 units) which indicate that the polymeric material contains a propylene based polymer. These continuous C3 units can also be identified as iPP units.

The units having 3, 4, 6 and 7 carbon atoms describe units in the NMR spectrum which are derived from two carbon atoms in the main chain of the polymer and a short side chain or branch of 1 carbon atom (isolated C3 unit), 2 carbon atoms (C4 units), 4 carbon atoms (C6 units) or 5 carbon atoms (C7 units).

The units having 3, 4 and 6 carbon atoms (isolated C3, C4 and C6 units) can derive either from incorporated comonomers (propylene, 1-butene and 1-hexene comonomers) or from short chain branches formed by radical polymerization.

The units having 7 carbon atoms (C7 units) can be distinctively attributed to the recycled polyethylene as they cannot derive from any comonomers. 1-heptene monomers are not used in copolymerization. Instead, the C7 units represent presence of LDPE distinct for the recyclate. It has been found that in LDPE resins the amount of C7 units is always in a distinct range. Thus, the amount of C7 units measured by quantitative ¹³C{1H} NMR measurements can be used to calculate the amount of LDPE in a polyethylene composition.

Thus, the amounts of continuous C3 units, isolated C3 units, C4 units, C6 units and C7 units are measured by quantitative ¹³C{1H} NMR measurements as described below, whereas the LDPE content is calculated from the amount of C7 units as described below.

The total amount of ethylene units (C2 units) is attributed to units in the polymer chain, which do not have short side chains of 1-5 carbon atoms, in addition to the units attributed to the LDPE (i.e. units which have longer side chains branches of 6 or more carbon atoms).

Preferably, the recycled polyethylene has an MFR₂ of 0.5 to 1.5 g/10 min determined according to ISO 1133 and a density of 915 to 930 kg/m³ determined according to ISO 1183.

The recycled polyethylene has a total amount of ethylene units (C2 units) preferably of from 80.0 to 96.0 wt. %, more preferably of from 82.5 wt. % to 95.5 wt. %, still more preferably of from 85.0 wt. % to 95.5 wt. % and most preferably of from 87.5 wt. % to 95.0 wt. % as measured by NMR of the d2-tetrachloroethylene soluble fraction, with the total amount of C2 units being based on the total weight amount of monomer units in the recycled polyethylene and measured according to quantitative ¹³C{1H} NMR measurement.

The recycled polyethylene has a total amount of continuous units having 3 carbon atoms corresponding to polypropylene (continuous C3 units) of preferably from 0.2 to 6.5 wt. %, more preferably from 0.4 wt. % to 6.0 wt. %, still more preferably from 0.6 wt. % to 5.5 wt. % and most preferably from 0.75 wt. % to 5.0 wt. %; the total amount of continuous C3 units being based on the total weight amount of monomer units in in the recycled polyethylene and measured according to quantitative ¹³C{1H} NMR measurement.

The recycled polyethylene has a total amount of units having 3 carbon atoms as isolated C3 units (isolated C3 units) of preferably from 0.00 wt. % to 0.50 wt. %, more preferably from 0.00 wt. % to 0.40 wt. %, still more preferably from 0.00 wt. % to 0.30 wt. % and most preferably from 0.00 wt. % to 0.25 wt. %;
a total amount of units having 4 carbon atoms (C4 units) of preferably from 0.50 to 5.00 wt. %, more preferably from 0.75 wt. % to 4.00 wt. %, still more preferably from 1.00 wt. % to 3.50 wt. % and most preferably from 1.25 wt. % to 3.00 wt. %;
a total amount of units having 6 carbon atoms (C6 units) of preferably from 0.50 to 7.50 wt. %, more preferably from 0.75 wt. % to 6.50 wt. %, still more preferably from 1.00 wt. % to 5.50 wt. % and most preferably from 1.25 wt. % to 5.00 wt. %;
a total amount of units having 7 carbon atoms (C7 units) of preferably from 0.20 wt. % to 2.50 wt. %, of from 0.30 wt. % to 2.00 wt. %, still more preferably of from 0.40 to 1.50 wt. % and most preferably of from 0.45 wt. % to 1.25 wt. %, and
a LDPE content of preferably from 20.0 to 65.0 wt. %, more preferably from 25.0 wt. % to 62.5 wt. %, still more preferably from 30.0 wt. % to 60.0 wt. % and most preferably from 32.0 wt. % to 55.0 wt. %.

The total amounts of C2 units, continuous C3 units, isolated C3 units, C4 units, C6 units, C7 units and LDPE content thereby are based on the total weight amount of monomer units in the recycled polyethylene and measured or calculated according to quantitative ¹³C{1H} NMR measurement.

Preferably, the total amount of units, which can be attributed to comonomers (i.e. isolated C3 units, C4 units and C6 units), in the recycled polyethylene is from 4.00 wt. % to 20.00 wt. %, more preferably from 4.50 wt. % to 17.50 wt. %, still more preferably from 4.75 wt. % to 15.00 wt. % and most preferably from 5.00 wt. % to 12.50 wt. %, and is measured according to quantitative ¹³C{1H} NMR measurement. The recycled polyethylene preferably does not comprise carbon black. It is further preferred that the recycled polyethylene does not comprise any pigments other than carbon black.

The recycled polyethylene may also include:
0 to 10 wt. % units derived from alpha olefin(s), 0 to 3.0 wt. % stabilizers, 0 to 3.0 wt. % talc, 0 to 3.0 wt. % chalk, 0 to 6.0 wt. % further components, all percentages with respect to the recycled polyethylene.

The recycled polyethylene preferably has one or more, more preferably all, of the following properties in any combination:
a MFR₅ (ISO 1133, 5.0 kg, 190° C.) of from 1.5 to 5.0 g/10 min, more preferably from 2.0 to 4.0 g/10 min;
a MFR₂₁ (ISO 1133, 21.6 kg, 190° C.) of from 20.0 to 50.0 g/10 min, more preferably from 25.0 to 45.0 g/10 min;
a polydispersity index PI of from 1.0 to 3.5 s⁻¹, more preferably from 1.3 to 3.0 s⁻¹;
a shear thinning index SHI_{2.7/210} of from 15 to 40, more preferably from 20 to 35;
a complex viscosity at the frequency of 300 rad/s, eta300, of from 500 to 750 Pa·s, more preferably from 550 to 700 Pa·s;
a complex viscosity at the frequency of 0.05 rad/s, eta0.05, of from 15000 to 30000 Pa·s, more preferably from 15500 to 27500 Pa·s;
a strain hardening modulus, SH modulus, of from 12.5 to 20.0 MPa, more preferably from 13.0 to 17.5 MPa.

It is preferred that the recycled polyethylene has a comparatively low gel content, especially in comparison to other mixed-plastic-polyethylene recycling blends.

The recycled polyethylene preferably has a gel content for gels with a size of from above 600 μm to 1000 μm of not more than 1000 gels/m², more preferably not more than 850 gels/m². The lower limit of the gel content for gels with a size of from above 600 μm to 1000 μm is usually 100 gels/m², preferably 150 gels/m².

Still further, the mixed-plastic polyethylene composition preferably has a gel content for gels with a size of from above 1000 μm of not more than 200 gels/m², more preferably not more than 150 gels/m². The lower limit of the gel content for gels with a size of from above 1000 μm is usually 10 gels/m², preferably 14 gels/m².

The recycled polyethylene is present in the core layer composition in an amount of preferably from 50 to 95 wt. %, more preferably from 55 to 90 wt. %, more preferably from 60 to 85 wt. %, more preferably from 65 to 75 wt. %, based on the total core layer composition.

The core layer composition further comprises b) a multimodal ethylene terpolymer. Generally, ethylene polymers may be unimodal or multimodal, for example bimodal.

As used herein, by the “modality” of a polymer the structure of the molecular weight distribution of the polymer is meant, i.e. the appearance of the curve indicating the number of molecules as a function of the molecular weight. If the curve exhibits one maximum, the polymer is referred to as “unimodal”, whereas if the curve exhibits a very broad maximum or two or more maxima and the polymer consists of two or more fractions, the polymer is referred to as “bimodal”, “multimodal” etc. For example, if a polymer is produced in a sequential multistage process, utilizing reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In the production of unimodal ethylene polymers, an ethylene polymer is produced in a reactor under certain conditions with respect to monomer composition, hydrogen gas pressure, temperature, pressure, and so forth. As comonomer, use is commonly made of other olefins having up to 12 carbon atoms, such as alpha-olefins having 3 to 12 carbon atoms, e.g. propene, 1-butene, 4-methyl-1-pentene, 1-hexene, 1-octene, 1-decene, etc., in the copolymerization of ethylene.

In the production of, for example, a bimodal ethylene polymer, a first ethylene polymer is produced in a first reactor under certain conditions with respect to monomer composition, hydrogen gas pressure, temperature, pressure, and so forth. After the polymerization in the first reactor, the reaction mixture including the polymer produced is fed to a second reactor, where further polymerization takes place under other conditions. Usually, a first polymer of high melt flow rate (low molecular weight) and with a moderate or small addition of comonomer, or no such addition at all, is produced in the first reactor, whereas a second polymer of low melt flow rate (high molecular weight) and with a greater addition of comonomer is produced in the second reactor. The resulting end product consists of an intimate mixture of the polymers from the two reactors, the different molecular weight distribution curves of these polymers together forming a molecular weight distribution curve having a broad maximum or two maxima, i.e. the end product is a bimodal polymer mixture.

The multimodal ethylene terpolymer b) preferably comprises, or consists of, a copolymer of ethylene with at least two different alpha-olefin comonomers having from 4 to 10 carbon atoms, which consists of either
(i) 30.0 to 70.0 wt. % of an ethylene polymer component (A) having a density in the range of 920 to 950 kg/m³ determined according to ISO 1183 and an MFR₂ of 2.0 to 40.0 g/10 min determined according to ISO 1133, and
(ii) 70.0 to 30.0 wt. % of an ethylene polymer component (B) having a density of 880 to 915 kg/m³ determined according to ISO1183 and an MFR₂ of 0.01 to 1.5 g/10 min determined according to ISO 1133,
or
(i) 30.0 to 70.0 wt. % of an ethylene polymer fraction (A-1) and an ethylene polymer fraction (A-2), wherein the ethylene polymer fraction (A-1) has a density of 920 to 960 kg/m³ determined according to ISO 1183 and an MFR₂ of 1.0 to 50.0 g/10 min determined according to ISO 1133 and wherein the ethylene polymer fraction (A-2) has a density of 930 to 950 kg/m³ determined according to ISO 1183 and an MFR₂ of 3.0 to 60.0 g/10 min determined according to ISO 1133; whereby the ratio of the MFR₂ of the ethylene polymer fraction (A-1) to the MFR₂ of the ethylene polymer component (A) is greater than 0.3; and
(ii) 70.0 to 30.0 wt. % of an ethylene polymer component (B) having a density of 880 to 915 kg/m³ determined according to ISO1183 and a MFR₂ of 0.01 to 1.5 g/10 min determined according to ISO 1133.

The ethylene polymer component (A) has a MFR₂ preferably of 2.0 to 40 g/10 min, preferably of 2.5 to 30 g/10 min, more preferably of 3.0 to 20 g/10 min and even more preferably of 3.2 to 10 g/10 min determined according to ISO 1133.

The ethylene polymer fraction (A-1) has a MFR₂ preferably of 1.0 to 50.0 g/10 min, more preferably of 1.5 to 40.0 g/10 min, more preferably of 2.0 to 30.0 g/10 min and even more preferably of 2.5 to 20.0 g/10 min, most preferably 3.0 to 10.0 g/10 min determined according to ISO 1133.

The ethylene polymer fraction (A-2) has a MFR₂ higher than the ethylene polymer fraction (A-1), i.e. the ethylene polymer fraction (A-2) has a MFR₂ of 3.0 to 60.0 g/10 min, preferably of 3.2 to 30.0 g/10 min, more preferably of 3.5 to 20.0 g/10 min, and most preferably of 3.5 to 15.0 g/10 min determined according to ISO 1133.

The ethylene polymer component (B) has a MFR₂ preferably of 0.01 to 1.5 g/10 min, preferably of 0.05 to 1.5 g/10 min, more preferably of 0.1 to 1.3 g/10 min and even more preferably of 0.2 to 1.2 g/10 min determined according to ISO 1133.

Additionally, the ratio of the MFR₂ of the ethylene polymer fraction (A-1) to the MFR₂ of the ethylene polymer component (A) is preferably greater than 0.3, preferably in a range of 0.50 to 1.0, more preferably in the range of 0.60 to 1.0 and even more preferably 0.70 to 1.0, like 0.80 to 0.98.

Furthermore, the ratio of the MFR₂ of ethylene polymer component (A) to the MFR₂ of the final multimodal ethylene terpolymer b) is greater than 2.1, preferably 2.3 to 12.0, more preferably 2.5 to 10.0 and even more preferably 2.8 to 8.0.

The at least two alpha-olefin comonomers having from 4 to 10 carbon atoms of the multimodal ethylene terpolymer are preferably butene and hexene.

The alpha-olefin comonomer for the ethylene polymer component (A) and the ethylene polymer fractions (A-1) and (A-2) is preferably the same, thus the same alpha-olefin comonomer having from 4 to 10 carbon atoms is used for component (A) and fractions (A-1) and (A-2), more preferably component (A) and fractions (A-1) and (A-2) have 1-butene as alpha-olefin comonomer. In other words, the ethylene polymer component (A) is an ethylene-1-butene copolymer, the ethylene polymer fraction (A-1) is an ethylene-1-butene copolymer and the ethylene polymer fraction (A-2) is an ethylene-1-butene copolymer. Preferably, the ethylene polymer component (B) is an ethylene-1-hexene copolymer.

Most preferably, the ethylene polymer component (A) is an ethylene-1-butene copolymer and the ethylene polymer component (B) is an ethylene-1-hexene copolymer, or the ethylene polymer fraction (A-1) is an ethylene-1-butene copolymer, the ethylene polymer fraction (A-2) is an ethylene-1-butene copolymer and the ethylene polymer component (B) is an ethylene-1-hexene copolymer.

The alpha-olefin comonomer content of component (A) and (B) can be measured, or, in case, and preferably, one of the components is produced first and the other thereafter in the presence of the first produced in a so called multistage process, then the alpha-olefin comonomer content of the first produced component, e.g. component (A), can be measured and the comonomer content of the other component, e.g. component (B), can be calculated according to following formula:

Comonomer content (mol %) in component B=(comonomer content (mol %) in final product−(weight fraction of component A*comonomer content (mol %) in component A))/(weight fraction of component B)

More preferably, the total amount of alpha-olefin comonomers present in the multimodal ethylene terpolymer b) is of 0.5 to 10.0 mol %, preferably of 1.0 to 8.0 mol %, more preferably of 1.5 to 6.0 mol %, more preferably of 2.0 to 5.0 mol %, based on the multimodal ethylene terpolymer.

The total amount of 1-butene is preferably in the range of from 0.05 to 1.0 mol %, preferably 0.10 to 0.8 mol % and more preferably 0.15 to 0.5 mol %. based on the multimodal ethylene terpolymer.

The total amount of 1-hexene preferably is in the range of 0.45 to 9.0 mol %, preferably 0.90 to 7.2 mol % and more preferably 1.35 to 5.5 mol % based on the multimodal ethylene terpolymer.

Preferably, the total amount (mol %) of alpha-olefin comonomer having from 4 to 10 carbon atoms, preferably selected from butene, hexene and octene, especially butene, present in the ethylene polymer component (A) is of 0.05 to 5.0 mol %, more preferably of 0.1 to 4.0 mol %, even more preferably of 0.2 to 3.0 mol %, even more preferably of 0.3 to 2.0 mol %, and most preferably 0.3 to 1.0 mol %, based on the ethylene polymer component (A).

In an embodiment, the amount (mol %) of alpha-olefin comonomer having from 6 to 10 carbon atoms, preferably selected from hexene and octene, especially hexene, present in the ethylene polymer component (B) is of 2.5 to 10.0 mol %, preferably of 3.0 to 9.0 mol %, more preferably of 3.5 to 8.0 mol %, even more preferably of 4.0 to 7.0 mol %, based on the ethylene polymer component (B).

Preferably, the density of ethylene polymer component (A) is different, preferably higher, than the density of the ethylene polymer component (B).

The density of the ethylene polymer component (A) is in the range of 920 to 950 kg/m³, preferably of 925 to 950 kg/m³, more preferably 930 to 945 kg/m³ determined according to ISO 1183 and/or the density of the ethylene polymer component (B) is of in the range of 880 to 915 kg/m³, preferably of 890 to 905 kg/m³ determined according to ISO 1183.

The polymer fraction (A-1) has a density in the range of from 920 to 960 kg/m³, preferably of 925 to 955 kg/m³, more preferably of 930 to 950 kg/m³, and most preferably 935 to 945 kg/m³ determined according to ISO 1183.

The density of the polymer fraction (A-2) is in the range of from 930 to 950 kg/m³, preferably of 935 to 945 kg/m³ determined according to ISO 1183.

The ethylene polymer fractions (A-1) and (A-2) are present in an amount preferably of 30.0 to 70.0 wt. % based on the multimodal ethylene terpolymer, preferably in an amount of 32.0 to 55.0 wt. % and even more preferably in an amount of 34.0 to 45.0 wt. %. Preferably, a weight ratio of the first and the second ethylene polymer fraction (A-1 and A-2) is preferably between 4:1 to 1:4, such as 3:1 to 1:3, or 2:1 to 1:2, or 1:1.

The ethylene polymer component (A) is present in an amount preferably of 30.0 to 70.0 wt. % based on the multimodal ethylene terpolymer, preferably in an amount of 32.0 to 55.0 wt. % and even more preferably in an amount of 34.0 to 45.0 wt. %.

Thus, the ethylene polymer component (B) is present preferably in an amount of 70.0 to 30.0 wt. % based on the multimodal ethylene terpolymer, preferably in an amount of 68.0 to 45.0 wt. % and more preferably in an amount of 66.0 to 55.0 wt. %. The multimodal ethylene terpolymer has an MFR₂ preferably of 0.75 to 1.75 g/10 min determined according to ISO1133 and/or preferably a density of 914 to 922 kg/m³, determined according to ISO 1183.

The multimodal ethylene terpolymer has an MFR₂₁ preferably of 20 to 40 g/10 min, more preferably of 25 to 35 g/10 min, and most preferably 28 to 32 g/10 min, determined according to ISO 1133.

The multimodal ethylene terpolymer is preferably a bimodal ethylene terpolymer.

The multimodal ethylene terpolymer is preferably a metallocene catalyzed multimodal ethylene terpolymer. In other words, the multimodal ethylene terpolymer b) is obtained by a metallocene-catalyzed polymerization process. The metallocene catalyzed multimodal ethylene terpolymer can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR) to produce the multimodal ethylene terpolymer c). In this case, the reaction conditions in the two slurry reactors are chosen in a way that in the two slurry reactors different products in view of MFR and/or density are produced.

Such a process is described inter alia in WO 2016/198273, WO 2021/009189, WO 2021/009190, WO 2021/009191 and WO 2021/009192. Full details of how to prepare suitable metallocene catalyzed multimodal ethylene terpolymers can be found in these references.

A suitable process is the Borstar PE 3G process.

The multimodal ethylene terpolymer is preferably a linear low density polyethylene.

The bimodal or multimodal ethylene terpolymer has a MWD preferably of 3.0 to 5.0, more preferably of 3.5 to 4.5, and most preferably of 3.7 to 4.3, determined by GPC (Gel Permeation Chromatography).

The multimodal ethylene terpolymer is present in the core layer composition in an amount of preferably from 5 to 30 wt. %, more preferably from 10 to 25 wt. %, more preferably from 15 to 20 wt. %, based on the total core layer composition.

The core layer composition further comprises c) a polyethylene.

Preferably, the polyethylene is multimodal, preferably trimodal, and/or is a terpolymer.

More preferably, the polyethylene is a trimodal copolymer comprising, or consisting of
a) 10 to 30 wt. % of a first ethylene homopolymer;
b) 15 to 35 wt. % a second ethylene homopolymer having an MFR₂ which is at least 50 g/10 min higher than the MFR₂ of component a); and
c) 40 to 65 wt. % of a third ethylene copolymer with at least one alpha-olefin comonomer.

Even more preferably, the polyethylene is a trimodal terpolymer comprising, or consisting of
a) 10 to 30 wt. % of a first ethylene homopolymer;
b) 15 to 35 wt. % a second ethylene homopolymer having an MFR₂ which is at least 50 g/10 min higher than the MFR₂ of component a); and
c) 40 to 65 wt. % of a third ethylene terpolymer with at least two alpha-olefin comonomers.

Preferably, the third fraction c) of the polyethylene c) is an ethylene 1-hexene copolymer or a terpolymer of ethylene and at least two alpha-olefin comonomers, such as 1-butene and 1-hexene, i.e. an ethylene-1-butene-1-hexene terpolymer. In other words, the third ethylene copolymer with at least one alpha-olefin comonomer is preferably an ethylene 1-hexene copolymer, or the third ethylene terpolymer with at least two alpha-olefin comonomers is preferably an ethylene-1-butene-1-hexene terpolymer.

Preferably, the total amount of alpha-olefin comonomer(s) present in the polyethylene c) is 1.0 to 15.0 wt. %, more preferably 2.0 to 10.0 wt. %, more preferably 3.5 to 8.0 wt. %, and most preferably 4.0 to 6.5 wt. %, based on the total polyethylene.

In case the polyethylene c) is a trimodal copolymer in which the third ethylene copolymer with at least one alpha-olefin comonomer is an ethylene-1-hexene copolymer, the total amount of 1-hexene is preferably 1.0 to 10.0 wt. %, more preferably 2.0 to 7.0 wt. %, more preferably 3.0 to 5.0 wt. %, and most preferably 3.1 to 4.6 wt. %, based on the total trimodal copolymer.

In case the polyethylene c) is a trimodal terpolymer in which the third ethylene terpolymer with at least two alpha-olefin comonomers is an ethylene-1-butene-1-hexene terpolymer, the total amount of 1-butene is preferably 0.1 to 5.0 wt. %, more preferably 0.4 to 4.0 wt. %, more preferably 0.7 to 3.0 wt. %, more preferably 0.9 to 2.5 wt. %, and most preferably 1.0 to 2.2 wt. % based on the total trimodal terpolymer, and/or the total amount of 1-hexene is preferably 1.0 to 10.0 wt. %, more preferably 2.0 to 7.0 wt. %, more preferably 3.0 to 5.0 wt. %, and most preferably 3.1 to 4.6 wt. %, based on the total trimodal terpolymer.

Preferably, the polyethylene has a MFR₂ of 0.2 to 0.5 g/10 min determined according to ISO 1133.

Preferably, the polyethylene has an MFR₅ of 1 to 2.0 g/10 min, more preferably of 1.25 to 1.75 g/10 min, determined according to ISO 1133 and a density preferably of 925 to 945 kg/m³, more preferably of 930 to 945 kg/m³, determined according to ISO 1183.

In addition to the MFR₅ and the density, the polyethylene has an MFR₂₁ preferably of 25 to 45 g/10 min, more preferably of 30 to 40 g/10 min, and most preferably of 32 to 38 g/10 min, determined according to ISO 1133.

The FRR_{21/5} of the polyethylene is preferably in the range from 18 to 28.

The polyethylene is preferably a Ziegler-Natta catalyzed polyethylene. In other words, the polyethylene c) is obtained by a Ziegler-Natta catalyzed polymerization process. The polyethylene has a MWD preferably of 10 to 30, more preferably of 15 to 25, and most preferably of 19 to 22, determined by GPC (Gel Permeation Chromatography).

The polyethylene is present in the core layer composition in an amount of preferably from 5 to 30 wt. %, more preferably from 6 to 25 wt. %, more preferably from 8 to 15 wt. %, based on the total core layer composition.

### Skin Layer

The multilayer polyethylene film of the invention further comprises a skin layer. The skin layer is preferably an outermost layer of the multilayer polyethylene film.

Preferably, the skin layer comprises, or consists of, a skin layer composition, the skin layer composition comprising, or consisting of, a multimodal ethylene terpolymer having an MFR₂ of 0.5 to 2.0 g/10 min, preferably of 0.75 to 1.75 g/10 min, determined according to ISO 1133, a density of 910 to 930 kg/m³, preferably of 914 to 922 kg/m³, determined according to ISO 1183, and a MWD of 2.0 to 7.5 determined by GPC (Gel Permeation Chromatography), and/or a low density polyethylene having an MFR₂ of 0.1 to 2.0 g/10 min, preferably of 0.5 to 1.25 g/10 min, determined according to ISO 1133 and a density of 910 to 950 kg/m³, preferably of 915 to 930 kg/m³, more preferably of 918 to 927 kg/m³, determined according to ISO 1183. The multimodal ethylene terpolymer of the skin layer is preferably the same as the multimodal ethylene terpolymer of the core layer, as described in all embodiments herein.

More preferably, the skin layer comprises a skin layer composition, the skin layer composition comprising a multimodal ethylene terpolymer as defined herein in all embodiments and a low density polyethylene as defined herein in all embodiments. The low density polyethylene has a MFR₂₁ preferably of 48 to 68 g/10 min, more preferably of 53 to 63 g/10 min, and most preferably of 56 to 60 g/10 min, determined according to ISO 1133.

The low density polyethylene has a MWD preferably of 4.0 to 9.0, more preferably of 5.0 to 8.0, and most preferably of 6.0 to 7.4, determined by GPC (Gel Permeation Chromatography). The low density polyethylene is preferably a high pressure tubular LDPE. In other words, this LDPE is produced in a tubular reactor under high pressure conditions of typically 100 to 400 MPa.

The multimodal ethylene terpolymer is present in the skin layer composition in an amount of preferably from 80 to 95 wt. %, more preferably from 85 to 93 wt. %, based on the total skin layer composition.

The low density polyethylene is present in the skin layer composition in an amount of preferably from 5 to 20 wt. %, more preferably from 5 to 20 wt. %, more preferably from 7 to 15 wt. %, based on the total skin layer composition.

### Sealant Layer

The multilayer polyethylene film of the invention further comprises a sealant layer.

The sealant layer is preferably an outermost layer of the multilayer polyethylene film.

Preferably, the sealant layer comprises, or consists of, a sealant layer composition, the sealant layer composition comprising, or consisting of, a copolymer of ethylene and an alpha-olefin comonomer having 4 to 8 carbon atoms, the copolymer having an MFR₂ of 0.5 to 2.0 g/10 min, preferably of 0.75 to 1.25 g/10 min, determined according to ISO 1133 and a density of 870 to 910 kg/m³, preferably of 890 to 910 kg/m³, determined according to ISO 1183, and/or a multimodal ethylene terpolymer having an MFR₂ of from 0.5 to 2.0 g/10 min determined according to ISO 1133 and a density of 910 to 930 kg/m³ determined according to ISO 1183. The multimodal ethylene terpolymer of the sealant layer is preferably the same as the multimodal ethylene terpolymer of the core layer, as described in all embodiments herein.

More preferably, the sealant layer comprises a sealant layer composition, the sealant layer composition comprising the copolymer of ethylene and an alpha-olefin having 4 to 8 carbon atoms as defined herein in all embodiments and the multimodal ethylene terpolymer as defined herein in all embodiments.

The alpha-olefin comonomer having 4 to 8 carbon atoms is preferably 1-octene. In other words, the copolymer of ethylene and an alpha-olefin comonomer having 4 to 8 carbon atoms is preferably an ethylene-1-octene copolymer.

The alpha-olefin comonomer of the copolymer is present in an amount preferably of 10 to 30 wt. %, more preferably 12 to 24 wt. %, and most preferably 14 to 18 wt. %, based on the total copolymer of ethylene and an alpha-olefin comonomer having 3 to 8 carbon atoms.

The copolymer of ethylene and an alpha-olefin comonomer having 4 to 8 carbon atoms has a MFR₂₁ preferably of 28 to 48 g/10 min, more preferably of 33 to 43 g/10 min, and most preferably of 36 to 40 g/10 min, determined according to ISO 1133.

The copolymer of ethylene and an alpha-olefin comonomer having 4 to 8 carbon atoms is preferably a metallocene catalyzed copolymer of ethylene an alpha-olefin comonomer having 4 to 8 carbon atoms. In other words, the copolymer of ethylene and an alpha-olefin comonomer having 4 to 8 carbon atoms is obtained by a metallocene-catalyzed polymerization process. The copolymer of ethylene and an alpha-olefin comonomer having 4 to 8 carbon atoms has a MWD preferably of 2.0 to 4.0, more preferably of 2.5 to 3.5, and most preferably of 2.7 to 3.3, determined by GPC (Gel Permeation Chromatography).

The copolymer of ethylene and an alpha-olefin comonomer having 4 to 8 carbon atoms is present in the sealant layer composition in an amount of preferably from 50 to 90 wt. %, more preferably 55 to 80 wt. %, more preferably 55 to 65 wt. %, based on the total sealant layer composition.

The multimodal ethylene terpolymer is present in the sealant layer composition in an amount of preferably from 10 to 50 wt. %, more preferably 20 to 45 wt. %, more preferably 35 to 45 wt. %, based on the total sealant layer composition.

The layers of the multilayer polyethylene film according to the invention each have a certain thickness.

The skin layer has a thickness of preferably 1 to 100 μm, more preferably 5 to 50 μm, and most preferably 10 to 20 μm.

The core layer has a thickness of preferably 10 to 200 μm, more preferably 20 to 100 μm, and most preferably 30 to 50 μm.

The sealant layer has a thickness of preferably 1 to 50 μm, more preferably 5 to 50 μm, and most preferably 10 to 20 μm.

The multilayer polyethylene film according to the invention has a thickness of preferably 12 to 350 μm, more preferably 30 to 200 μm, and most preferably 50 to 90 μm.

The multilayer polyethylene film has a tensile modulus in machine direction (MD) measured on a 60 μm test film according to ISO 527-3 of preferably 150 MPa or higher, more preferably of 200 MPa or higher, and/or a tensile modulus in transverse direction (TD) measured on a 60 μm test film according to ISO 527-3 of preferably 150 MPa or higher, preferably of 200 MPa or higher.

Usually, the multilayer polyethylene film has a tensile modulus in machine direction (MD) measured on a 60 μm test film according to ISO 527-3 of not higher than 1000 MPa, preferably not higher than 800 MPa, more preferably not higher than 600 MPa and/or a tensile modulus in transverse direction (TD) measured on a 60 μm test film according to ISO 527-3 of not more than 1000 MPa, preferably not higher than 800 MPa, more preferably not higher than 600 MPa.

The multilayer polyethylene film has a dart drop impact (DDI) determined according to ISO7765 on a 60 μm test film of preferably more than 300 g, more preferably more than 350 g and most preferably more than 375 g and/or a SIT (seal initiation temperature) of less than 82° C., more preferably less than 80° C. and most preferably less than 78° C. The SIT is determined as described herein.

Usually, the multilayer polyethylene film has a dart drop impact (DDI) determined according to ISO 7765 on a 60 μm test film of not more than 2000 g, preferably not more than 1500 g, more preferably not more than 1000 g, and/or a SIT (seal initiation temperature) of more than 70° C., more preferably more than 74° C., and most preferably more than 76° C. The SIT is determined as described herein.

The multilayer polyethylene film of the invention is preferably a blown film.

The invention further provides a process for producing the multilayer polyethylene film according to the invention, wherein the skin layer, the sealant layer and the core layer are co-extruded.

The different polymer components in any of the layers of the multilayer polyethylene film are typically intimately mixed prior to layer formation, for example using a twin screw extruder, preferably a counter-rotating extruder. Then, the blends are converted into a coextruded film structure. Preferably, the blends are converted into a coextruded film structure on a blown-film line.

In order to manufacture such multilayer polyethylene films according to the invention, normally at least two polymer melt streams are simultaneously extruded (i.e. coextruded) through a multi-channel tubular, annular or circular die to form a tube which is blown-up, inflated and/or cooled with air (or a combination of gases) to form a film. The manufacture of blown film is a well-known process.

The blown coextrusion can be effected at a temperature in the range 160° C. to 240° C., and cooled by blowing gas (generally air) at a temperature of 10 to 50° C. to provide a frost line height of 1 to 8 times the diameter of the die.

The blow up ratio (BUR) should generally be in the range 1.2 to 6, preferably 1.5 to 4.

All preferred embodiments of the multilayer polyethylene film according to the invention are also preferred embodiments of the process of for producing the multilayer polyethylene film.

The present invention also provides a core layer composition comprising
a) a recycled polyethylene having an MFR₂ of 0.1 to 2.0 g/10 min, preferably of 0.5 to 1.5 g/10 min, determined according to ISO 1133 and a density of 910 to 930 kg/m³, preferably of 915 to 930 kg/m³, determined according to ISO 1183,
b) a multimodal ethylene terpolymer having an MFR₂ of 0.5 to 2.0 g/10 min determined according to ISO 1133, a density of 910 to 930 kg/m³ determined according to ISO 1183, and a MWD of 2.0 to 7.5 determined by GPC (Gel Permeation Chromatography),
c) a polyethylene having an MFR₅ of 0.1 to 2.5 g/10 min, preferably of 1 to 2.0 g/10 min, determined according to ISO 1133, a density of 925 to 950 kg/m³, preferably of 935 to 945 kg/m³, determined according to ISO 1183, and a MWD of 8.0 to 35-0 determined by GPC (Gel Permeation Chromatography).

All preferred embodiments of the core layer composition described above for the multilayer polyethylene film according to the invention are also preferred embodiments of the core layer composition according to the invention. Also, all preferred embodiments of the recycled polyethylene, the multimodal ethylene terpolymer and the polyethylene defined above are also preferred embodiments of the core layer composition according to the invention

The invention is further directed to the use of a core layer composition as a core layer of a multilayer film for improving the haze and the SIT of the multilayer film.

All preferred embodiments of the core layer composition described above for the multilayer polyethylene film according to the invention and the core layer composition of the invention are also preferred embodiments of the use according to the invention.

Finally, the invention provides an article comprising the multilayer polyethylene film according to the invention or the core layer composition of the invention. Preferably, the article is a pouch, such as a stand-up pouch, a sack, a bag, a sachet.

### Measurement and Determination Methods

The following definitions of terms and determination methods apply for the above general description of the invention as well as to the below examples unless otherwise defined.

### a) Measurement of Melt Flow Rate MFR

The melt flow rate (MFR) was determined according to ISO 1133 and is indicated in g/10 min. The higher the melt flow rate, the lower the viscosity of the polymer.

The MFR is determined at 190° C. for polyethylene and at a loading of 2.16 kg (MFR₂), 5.00 kg (MFR₅) or 21.6 kg (MFR₂₁).

The quantity FRR (flow rate ratio) is an indication of molecular weight distribution and denotes the ratio of flow rates at different loadings. Thus, FRR_{21/5} denotes the value of MFR₂₁/MFR₅.

### b) Density

Density of the polymer was determined according to ISO 1183-1:2004 (method A) on compression molded specimen prepared according to ISO 17855-2 and is given in kg/m³.

The density of the polymer blends was calculated as follows. The density of blends d_{b} is calculated as

$$db = {\sum }_{i = 1}^{i} w i * d i$$

wherein wi and di are the weight % and density of fraction i in the polymer blend.

### c) Comonomer Content

The comonomer content was determined as described in WO2019081611, pages 31 to 34.

### d) Mechanical Properties

### Tensile Modulus

Film tensile properties were determined at 23° C. according to ISO 527-3 with a specimen Type 2 using blown film as indicated below. Tensile modulus in machine direction (MD) and tensile modulus in transverse direction (TD) were determined as 1% secant modulus with 5 mm/min test speed and 50 mm gauge length according to ASTM D882.

The film samples were produced as described below under “Examples”.

### Dart Drop Impact

The DDI was measured according to ISO 7765-1:1988/Method A on films with a thickness as indicated and produced as described below under “Examples”. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions

Conditioning time: >96 h
Test temperature: 23° C.
Dart head material: phenolic
Dart diameter: 38 mm
Drop height: 660 mm

### Results

Impact failure weight—50% [g]

### e) Optical Properties

Haze as measure for the optical appearance of the films was determined according to ASTM D1003 on films with thickness as indicated and produced as described below under “Examples”.

### f) Seal Initiation Temperature (SIT)

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with the films as produced indicated below blown film of 60 μm thickness with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/sec

### g) Thickness

Thickness of the films was determined according to ISO 4593.

### h) Quantification of C2, iPP (Continuous C3), LDPE and Polyethylene Short Chain Branches in Polyethylene Based Recylates

Quantitative ¹³C{¹H} NMR spectra were recorded in the solution-state using a Bruker Avancelll 400 MHz NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07, busico07}. A total of 6144 (6k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3 s 32.2 ppm) were observed. The intensity of the combined ethylene backbone methine carbons (ddg) containing the polyethylene backbone carbons (dd 30.0 ppm), γ-carbons (g 29.6 ppm) the 4 s and the threeB4 carbon (to be compensated for later on) is taken between 30.9 ppm and 29.3 ppm excluding the Tββ from polypropylene. The amount of C2 related carbons was quantified using all mentioned signals according to the following equation:

$$f {C}_{C 2 total} = ( Iddg - ItwoB 4 ) + ( IstarB 1 * 6 ) + ( IstarB 2 * 7 ) + ( ItwoB 4 * 9 ) + I ( threeB 5 * 10 ) + ( ( IstarB 4 plus - ItwoB 4 - IthreeB 5 ) * 7 ) + ( I 3 s * 3 )$$

Characteristic signals corresponding to the presence of polypropylene (iPP, continuous C3)) were observed at 46.7 ppm, 29.0 ppm and 22.0 ppm. The amount of PP related carbons was quantified using the integral of Sαα at 46.6 ppm:

$$f {C}_{P P} = Is αα ⋆ 3$$

The weight percent of the C2 fraction and the polypropylene can be quantified according following equations:

$${wt}_{C 2 fraction} = {fC}_{C 2 total} * 100 / ( {fC}_{C 2 total} + {fC}_{PP} )$$

$${wt}_{PP} = {fC}_{PP} * 100 / ( {fC}_{C 2 total} + {fC}_{PP} )$$

Characteristic signals corresponding to various short chain branches were observed and their weight percentages quantified as the related branch would be an alpha-olefin, starting by quantifying the weight fraction of each:

$$fwtC 2 = {fC}_{C 2 total} - ( ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC 7 = IthreeB 5 * 7$$

Normalisation of all weight fractions leads to the amount of weight percent for all related branches:

$${fsum}_{wt \% total} = fwtC 2 + fwtC 3 + fwtC 4 + fwtC 6 + fwtC 7 + {fC}_{PP}$$

$$wtC 2 total = fwtC 2 * 100 / {fsum}_{wt \% total}$$

$$wtC 3 total = fwtC 3 * 100 / {fsum}_{wt \% total}$$

$$wtC 4 total = fwtC 4 * 100 / {fsum}_{wt \% total}$$

$$wtC 6 total = fwtC 6 * 100 / {fsum}_{wt \% total}$$

$$wtC 7 total = fwtC 7 * 100 / {fsum}_{wt \% total}$$

The content of LDPE can be estimated assuming the B5 branch, which only arises from ethylene being polymerized under high pressure process, being almost constant in LDPE. We found the average amount of B5 if quantified as C7 at 1.46 wt. %. With this assumption it is possible to estimate the LDPE content within certain ranges (approximately between 20 wt. % and 80 wt. %), which are depending on the SNR ratio of the threeB5 signal:

$$wt . \% LDPE = wtC 7 total * 100 / 1.46$$

### REFERENCES

zhou07 Zhou, Z., Kuemmerle, R., Qiu, X., Redwine, D., Cong, R., Taha, A., Baugh, D. Winniford, B., J. Mag. Reson. 187 (2007) 225
busico07 Busico, V., Carbonniere, P., Cipullo, R., Pellecchia, R., Severn, J., Talarico, G., Macromol. Rapid Commun. 2007, 28, 1128
singh09 Singh, G., Kothari, A., Gupta, V., Polymer Testing 28 5 (2009), 475
randall89 J. Randall, Macromol. Sci., Rev. Macromol. Chem. Phys. 1989, C29, 201.
brandolini00 A. J. Brandolini, D. D. Hills, NMR Spectra of Polymers and Polymer Additives, Marcel Dekker Inc., 2000

### i) Dynamic Shear Measurements (Frequency Sweep Measurements)

The characterization of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{o}}{{γ}_{o}} cos δ [ Pa ] \qquad ( 3 )$$

$${G}^{″} = \frac{{σ}_{o}}{{γ}_{o}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′}}{ω} [ Pa \cdot s ] \qquad ( 8 )$$

The determination of so-called Shear Thinning Index, which correlates with MWD and is independent of Mw, is done as described in equation 9.

$$S H {I}_{( x / y )} = \frac{Eta * for ( G *= x kPa )}{Eta * for ( G *= y kPa )} \qquad ( 9 )$$

For example, the SHI_{(2.7/210)} is defined by the value of the complex viscosity, in Pa s, determined for a value of G* equal to 2.7 kPa, divided by the value of the complex viscosity, in Pa s, determined for a value of G* equal to 210 kPa.

The values of storage modulus (G′), loss modulus (G″), complex modulus (G*) and complex viscosity (η*) were obtained as a function of frequency (ω).

Thereby, e.g. η*_{300 rad/s} (eta*_{300 rad/s}) is used as abbreviation for the complex viscosity at the frequency of 300 rad/s and η*_{0.05 rad/s} (eta*_{0.05 rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s.

The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI(x). The elasticity index EI(x) is the value of the storage modulus (G′) determined for a value of the loss modulus (G″) of x kPa and can be described by equation 10.

$$E I ( x ) = {G}^{′} for ( {G}^{″} = x kPa ) [ Pa ] \qquad ( 10 )$$

For example, the EI(5 kPa) is the defined by the value of the storage modulus (G′), determined for a value of G″ equal to 5 kPa.

The polydispersity index, PI, is defined by equation 11.

$$P I = \frac{1 {0}^{5}}{{G}^{′} ( {ω}_{COP} )} , {ω}_{COP} = ω for ( {G}^{′} = {G}^{″} ) \qquad ( 11 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1] Rheological characterization of polyethylene fractions” Heino, E. L., Lehtinen, A., Tanner J., Seppälä, J., Neste Oy, Porvoo, Finland, Theor. Appl. Rheol., Proc. Int. Congr. Rheol, 11th (1992), 1, 360-362
[2] The influence of molecular structure on some rheological properties of polyethylene”, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### j) Strain Hardening (SH) Modulus

The strain hardening test is a modified tensile test performed at 80° C. on a specially prepared thin sample. The Strain Hardening Modulus (MPa), <Gp>, is calculated from True Strain-True Stress curves; by using the slope of the curve in the region of True Strain, λ, is between 8 and 12.

The true strain, λ, is calculated from the length, l (mm), and the gauge length, l0 (mm), as shown by Equation 1.

$$λ = \frac{I}{{I}_{0}} = 1 + \frac{Δ I}{{I}_{0}} \qquad ( 1 )$$

where Δl is the increase in the specimen length between the gauge marks, (mm). The true stress, otrue (MPa), is calculated according to formula 2, assuming conservation of volume between the gauge marks:

$${σ}_{true} = {σ}_{n} λ \qquad ( 2 )$$

where σn is the engineering stress.

The Neo-Hookean constitutive model (Equation 3) is used to fit the true strain-true stress data from which <Gp> (MPa) for 8<λ<12 is calculated.

$${σ}_{true} = \frac{< Gp >}{20} ( {λ}^{2} - \frac{1}{λ} ) + C \qquad ( 3 )$$

where C is a mathematical parameter of the constitutive model describing the yield stress extrapolated to λ=0.

Initially five specimens are measured. If the variation coefficient of <Gp> is greater than 2.5%, then two extra specimens are measured. In case straining of the test bar takes place in the clamps the test result is discarded.

The PE granules of materials were compression molded in sheets of 0.30 mm thickness according to the press parameters as provided in ISO 17855-2.

After compression molding of the sheets, the sheets were annealed to remove any orientation or thermal history and maintain isotropic sheets. Annealing of the sheets was performed for 1 h in an oven at a temperature of (120±2)° C. followed by slowly cooling down to room temperature by switching off the temperature chamber. During this operation free movement of the sheets was allowed.

Next, the test pieces were punched from the pressed sheets. The specimen geometry of the modified ISO 37:1994 Type 3 (Figure 3) was used.

The sample has a large clamping area to prevent grip slip, dimensions given in Table 0.

TABLE 0
Dimensions of Modified ISO 37:1994 Type 3

| Dimension | | Size (mm) |
|---|---|---|
| L | start length between clamps | 30.0 +/− 0.5 |
| l0 | Gauge length | 12.5 +/− 0.1 |
| l1 | Prismatic length | 16.0 +/− 1.0 |
| l3 | Total length | 70 |
| R1 | Radius | 10.0 +/− 0.03 |
| R2 | Radius | 8.06 +/− 0.03 |
| b1 | Prismatic width | 4.0 +/− 0.01 |
| b2 | Clamp width | 20.0 +/− 1.0 |
| h | Thickness | 0.30 + 0.05/0.30 − 0.03 |

The punching procedure is carried out in such a way that no deformation, crazes or other irregularities are present in the test pieces.

The thickness of the samples was measured at three points of the parallel area of the specimen; the lowest measured value of the thickness of these measurements was used for data treatment.
1. The following procedure is performed on a universal tensile testing machine having controlled temperature chamber and non-contact extensometer:
2. Condition the test specimens for at least 30 min in the temperature chamber at a temperature of (80±1)° C. prior to starting the test.
3. Clamp the test piece on the upper side.
4. Close the temperature chamber.
5. Close the lower clamp after reaching the temperature of (80±1)° C.
6. Equilibrate the sample for 1 min between the clamps, before the load is applied and measurement starts.
7. Add a pre-load of 0.5 N at a speed of 5 mm/min.
8. Extend the test specimen along its major axis at a constant traverse speed (20 mm/min) until the sample breaks.

During the test, the load sustained by the specimen is measured with a load cell of 200 N. The elongation is measured with a non-contact extensometer

### k) Gel Content

The gel count was measured with a gel counting apparatus consisting of a measuring extruder, ME 25/5200 V1, 25*25D, with five temperature conditioning zones adjusted to a temperature profile of 170/180/190/190/190° C.), an adapter and a slit die (with an opening of 0.5*150 mm). Attached to this were a chill roll unit (with a diameter of 13 cm with a temperature set of 50° C.), a line camera (CCD 4096 pixel for dynamic digital processing of grey tone images) and a winding unit.

For the gel count content measurements the materials were extruded at a screw speed of 30 rounds per minute, a drawing speed of 3-3.5 m/min and a chill roll temperature of 50° C. to make thin cast films with a thickness of 70 μm and a width of approximately 110 mm.

The resolution of the camera is 25 μm×25 μm on the film. The camera works in transmission mode with a constant grey value (auto.set. margin level=170). The system is able to decide between 256 grey values from black=0 to white=256. For detecting gels, a sensitivity level dark of 25% is used. For each material the average number of gel dots on a film surface area of 10 m² was inspected by the line camera. The line camera was set to differentiate the gel dot size according to the following:

Gel size (the size of the longest dimension of a gel)
300 μm to 599 μm
600 μm to 999 μm
above 1000 μm

### l) GPC Measurement

Molecular weight averages (M_{z}, M_{w} and Mₙ), molecular weight distribution (MWD) and its broadness, described by polydispersity index, PDI=M_{w}/Mₙ (wherein Mₙ is the number average molecular weight and M_{w} is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} x {M}_{i} )}{{\sum }_{i = 1}^{N} {A}_{i}} \qquad ( 2 )$$

$${M}_{z} = \frac{{\sum }_{i = 1}^{N} ( {A}_{i} x {M}_{i}^{2} )}{{\sum }_{i = 1}^{N} ( {A}_{i} x {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3× Agilent-PLgel Olexis and 1× Agilent-PLgel Olexis Guard columns was used. As mobile phase 1,2,4-trichlorobenzene (TCB) stabilized with 250 mg/L 2,6-Di tert butyl-4-methyl-phenol) was used. The chromatographic system was operated at column temperature of 160° C. and detector at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0.655$$

$${K}_{PE} = 39 \times {10}^{- 3} mL / g , {α}_{PE} = 0.725$$

A third order polynomial fit was used to fit the calibration data.

All samples were prepared in the concentration range of around 1 mg/ml and dissolved at 160° C. for 3 (three) hours for PE in fresh distilled TCB stabilized with 250 ppm Irgafos 168 under continuous gentle shaking.

### EXAMPLES

In the following, the invention will further be illustrated by way of non-limiting examples.

### a) Materials

The polymers used for making the multilayer film structures of the inventive examples and of the comparative examples are given in Table 1 below.

TABLE 1

| | | | MFR₂ | MFR₂₁ | Density | |
|---|---|---|---|---|---|---|
| Resin name | Producer | Type | (g/10 min) | (g/10 min) | (kg/m³) | MWD |
| Anteo | Borouge | Bimodal LLDPE | 1.5 | 30 | 918 | 4.0 |
| FK1820 | | terpolymer | | | | |
| FT5236 | Borealis | Tubular LDPE | 0.75 | 58.1 | 923 | 6.7 |
| FX1003 | Borealis | ZN-MDPE | 1.5* | 35.3 | 941 | 20.6 |
| Queo 0201 | Borealis | Ethylene- | 1.1 | 38.4 | 902 | 3.0 |
| | | octene | | | | |
| | | copolymer | | | | |
| NAV101 | Ecoplast | LDPE PCR | 1.02 | 41.6 | 923.9 | 7.1 |

*MFR₅ (g/10 min)

The polymers used are commercially available from the producer given in Table 1. NAV101 is a low density polyethylene (LDPE) post-consumer recyclate blend available from Ecoplast Kunststoffrecycling GmbH. The properties of NAV101 are shown in table A.

TABLE A

| | |
|---|---|
| Ethylene content (wt. %) | 90.67 |
| isol. C3 content (wt. %) | 0 |
| C4 content (wt. %) | 2.23 |
| C6 content (wt. %) | 2.73 |
| C7 content (wt. %) | 0.48 |
| iPP content (wt. %) | 3.89 |
| LDPE content (wt. %) | 33.00 |
| Density (kg/m³) | 923.9 |
| MFR₂ (g/10 min) | 1.02 |
| MFR₅ (g/10 min) | 3.57 |
| MFR₂₁ (g/10 min) | 41.56 |
| SHI2.7/210 | 22.16 |
| eta0.05 (Pa · s) | 16187 |
| eta300 (Pa · s) | 618 |
| PI (s−1) | 1.46 |
| SH modulus (MPa) | 14.3 |
| Gel content (>1000 μm) (1/m²) | 16.9 |
| Gel content (600-1000 μm) (1/m²) | 175.1 |
| Gel content (300-599) (μm/1 m²) | 885.9 |

### b) Film Production

Three-layered films consisting of a core layer, a skin layer and a sealant layer have been produced on Collin 30 lab scale line. The production was as follows: melt temperature 210° C., total throughput 7 kg/h, BUR 1:2.5, film thickness 60 μm. The composition and structure of the three-layered films produced are given in Table 2 below.

TABLE 2
Structures of the three-layered films

| | Skin layer | Core Layer | Sealant layer |
|---|---|---|---|
| Thickness layer | 20% | 60% | 20% |
| ratio | | | |
| Layer thickness | 12 | 36 | 12 |
| (μm) | | | |
| Inventive | 90 wt. % FK1820 + | 10 wt. % FX1003 + | 40 wt. % FK1820 + |
| example 1 | 10 wt. % FT5236 | 20 wt. % FK1820 + | 60 wt. % Queo 0201 |
| (IE1) | | 70 wt. % NAV1001 | |
| Comparative | 90 wt. % FK1820 + | 80 wt. % FX1003 + | 40 wt. % FK1820 + |
| example 1 | 10 wt. % FT5236 | 20 wt. % FK1820 | 60 wt. % Queo 0201 |
| (CE1) | | | |

Properties of the three-layered films are given in Table 3 below. The densities of the respective layers were calculated using the formula for polymer blends provided under item b) of “Measurement and Determination Methods” above.

TABLE 3
Properties of the three-layered films

| | | CE1 | IE1 |
|---|---|---|---|
| Density (skin layer) | kg/m | 918.5 | 918.5 |
| Density (core layer) | kg/m³ | 936.4 | 924.5 |
| Density (seal layer) | kg/m³ | 910.2 | 910.2 |
| Tensile modulus MD | MPa | 385 | 207 |
| Tensile modulus TD | MPa | 455 | 235 |
| Dart drop Impact (DDI) | g | 383 | 383 |
| SIT | ° C. | 82 | 77 |
| Haze | % | 8.39 | 7.56 |

As can be seen from Table 3, the usage of recycled polyethylene in the core layer does not reduce toughness (expressed as drop dart impact) but improves the optical properties (haze) and sealing performance (SIT) of the multilayer polyethylene film.

1. A multilayer polyethylene film comprising
a skin layer, a sealant layer and a core layer located between the skin layer and the sealant layer,
wherein the core layer comprises a core layer composition, the core layer composition comprising
a) a recycled polyethylene having an MFR₂ of 0.1 to 2.0 g/10 min determined according to ISO 1133 and a density of 910 to 930 kg/m³ determined according to ISO 1183,
b) a multimodal ethylene terpolymer having an MFR₂ of 0.5 to 2.0 g/10 min determined according to ISO 1133, a density of 910 to 930 kg/m³ determined according to ISO 1183, and a MWD of 2.0 to 7.5 determined by GPC (Gel Permeation Chromatography), and
c) a polyethylene having an MFR₅ of 0.1 to 2.5 g/10 min determined according to ISO 1133, a density of 925 to 950 kg/m³ determined according to ISO 1183, and a MWD of 8.0 to 35.0 determined by GPC (Gel Permeation Chromatography).

2. The multilayer polyethylene film according to claim 1, wherein the skin layer comprises a skin layer composition, the skin layer composition comprising
a multimodal ethylene terpolymer having an MFR₂ of 0.5 to 2.0 g/10 min, determined according to ISO 1133, a density of 910 to 930 kg/m³, determined according to ISO 1183 and a MWD of 2.0 to 7.5 determined by GPC (Gel Permeation Chromatography),
and/or
a low density polyethylene having an MFR₂ of 0.1 to 2.0 g/10 min, determined according to ISO 1133 and a density of 910 to 950 kg/m³, determined according to ISO 1183.

3. The multilayer polyethylene film according to any of the preceding claims, wherein the sealant layer comprises a sealant layer composition, the sealant layer composition comprising
a copolymer of ethylene and an alpha-olefin comonomer having 4 to 8 carbon atoms, the copolymer having an MFR₂ of 0.5 to 2.0 g/10 min, determined according to ISO 1133 and a density of 870 to 910 kg/m³, determined according to ISO 1183,
and/or
a multimodal ethylene terpolymer having an MFR₂ of 0.5 to 2.0 g/10 min determined according to ISO 1133, a density of 910 to 930 kg/m³ determined according to ISO 1183, and a MWD of 2.0 to 7.5 determined by GPC (Gel Permeation Chromatography.

4. The multilayer polyethylene film according to any one of the preceding claims, wherein the recycled polyethylene is present in the core layer composition in an amount of from 50 to 90 wt. % based on the total core layer composition,
and/or
wherein the multimodal ethylene terpolymer is present in the core layer composition in an amount of from 5 to 30 wt. % based on the total core layer composition,
and/or
wherein the polyethylene is present in the core layer composition in an amount of from 5 to 30 wt. % based on the total core layer composition.

5. The multilayer polyethylene film according to any one of claims 2 to 4, wherein the multimodal ethylene terpolymer is present in the skin layer composition in an amount of from 80 to 95 wt. % based on the total skin layer composition,
and/or
wherein the low density polyethylene is present in the skin layer composition in an amount of 5 to 20 wt. % based on the total skin layer composition.

6. The multilayer polyethylene film according to any one of claims 3 to 5, wherein the copolymer of ethylene and an alpha-olefin comonomer having 4 to 8 carbon atoms is present in the sealant layer composition in an amount of from 50 to 90 wt. % based on the total sealant layer composition,
and/or
wherein the multimodal ethylene terpolymer is present in the sealant layer composition in an amount of from 10 to 50 wt. % based on the total sealant layer composition.

7. The multilayer polyethylene film according to any one of the preceding claims, wherein the multimodal ethylene terpolymer is a bimodal ethylene terpolymer.

8. The multilayer polyethylene film according to any one of claims 3 to 7, wherein the copolymer of ethylene and an alpha-olefin comonomer having 4 to 8 carbon atoms is an ethylene-1-octene copolymer.

9. The multilayer polyethylene film according to any one of the preceding claims, wherein the skin layer has a thickness of 1 to 100 μm,
and/or
wherein the core layer has a thickness of 10 to 200 μm,
and/or
wherein the sealant layer has a thickness of 1 to 50 μm.

10. The multilayer polyethylene film according to any one of the preceding claims, wherein the multilayer polyethylene film has a tensile modulus in machine direction (MD) measured on a 60 μm test film according to ISO 527-3 of 150 MPa or higher and/or a tensile modulus in transverse direction (TD) measured on a 60 μm test film according to ISO 527-3 of 150 MPa or higher.

11. The multilayer polyethylene film according to any one of the preceding claims, wherein the multilayer polyethylene film has a dart drop impact (DDI) determined according to ISO 7765on a 60 μm test film of more than 300 g and/or a SIT (seal initiation temperature) of less than 82° C.

12. A process for producing the multilayer polyethylene film according to any one of the preceding claims, wherein the skin layer, the sealant layer and the core layer are co-extruded.

13. A core layer composition comprising
a) a recycled polyethylene having an MFR₂ of 0.1 to 2.0 g/10 min, determined according to ISO 1133 and a density of 910 to 930 kg/m³, determined according to ISO 1183,
b) a multimodal ethylene terpolymer having an MFR₂ of 0.5 to 2.0 g/10 min determined according to ISO 1133, a density of 910 to 930 kg/m³ determined according to ISO 1183, and a MWD of 2.0 to 7.5 determined by GPC (Gel Permeation Chromatography),
c) a polyethylene having an MFR₅ of 0.1 to 2.5 g/10 min, determined according to ISO 1133, a density of 925 to 950 kg/m³, determined according to ISO 1183, and a MWD of 8.0 to 35.0 determined by GPC (Gel Permeation Chromatography.

14. Use of the core layer composition according to claim 13 as a core layer of a multilayer polyethylene film for improving the haze and the SIT of the multilayer polyethylene film.

15. Article comprising the multilayer polyethylene film according to any one of claims 1 to 11 or the core layer composition according to claim 13.
